(19) United States
(12) Patent Application Publication
(10) Pub. No.: US 2001/0029476 A1
(43) Pub. Date: Oct. 11, 2001

(54) Liquidity preferred stock

(76) Inventor: Stephan J. Mallenbaum, Scarsdale, NY (US)

Correspondence Address: John V. Biernacki, Esq., Jones, Day, Reavis & Pogue, North Point, 901 Lakeside Avenue, Cleveland, OH, 44114, US

(21) Appl. No.: 09/814,561

(22) Filed: Mar. 22, 2001

Related U.S. Application Data
(60) Provisional application No. 60/191,273, filed on Mar. 22, 2000.

(51) Int. Cl. G06F 17/60

(52) U.S. Cl. 705/35; 705/36; 705/39

(57) ABSTRACT

A financial instrument issued by a company to a holder in order to compensate for services rendered to the company by the holder. The financial instrument comprises an obligation that a payor other than the company pay the holder when a predetermined event occurs.

### RELATED APPLICATION

This application claims priority of U.S. provisional application Ser. No. 60/191,273 entitled “Liquidity Preferred Stock” filed Mar. 22, 2000. By this reference, the full disclosure of U.S. provisional application Ser. No. 60/191,273 are incorporated herein.

### BACKGROUND OF THE INVENTION

1. Field of the Invention

The present invention is directed to the field of finance and investing, and more particularly the present invention is directed to financial instruments that regulate business relationships.

2. Description of the Related Art

Various forms of business entities have evolved over the years which provide the abilities to insulate the owners from risk and to aggregate the resources of a group of investors for use to achieve a common business purpose. With such various forms of business entities, such as corporations, limited liability companies, and business trusts, have come different forms of ownership interests. To evidence ownership interests, corporations issue shares of stock, limited liability companies issue membership interests, and business trusts issue beneficial interests. Investors expect to profit from purchasing such ownership interests through an increase in the value of the ownership interest, which in turn is based upon the value of the issuing entity. Often such ownership interests grant the holder of these interests the ability to control or otherwise participate in the management of the issuing entity.

The issuance of such ownership interests has become a common means of compensating those who provide valuable services to the issuing entity and assist in the issuing entity's continued growth and success in the marketplace. However, those who provide professional advice to businesses, such as attorneys and accountants, are precluded from accepting this type of compensation because of preexisting rules of professional conduct. The present invention solves this problem as well as others by providing a method by which businesses can compensate professional advisors so that the advisor can realize benefits from an increase in the business's value while avoiding violations of applicable rules of professional conduct.

### SUMMARY OF THE INVENTION

The present invention includes a financial instrument issued by a company to a holder that provides for the holder of the financial instrument to receive an economic benefit upon the occurrence of a predefined liquidity event. The holder receives the economic benefit from a payor other than the company. The payor's identity may be unknown at the time the financial instrument is issued. The structure of the financial instrument insulates holders from the appearance of a conflict of interest and/or an actual conflict of interest resulting from the operation of preexisting rules of ethics.

In an embodiment of the invention, the financial instrument denies the holder the right to vote on matters relating to the operations of the issuing company. The financial instrument is not convertible into common stock or any other type of security. The financial instrument does not have any liquidation preference. The financial instrument does not grant the holder the right to receive dividends. The financial instrument's right to receive cash is subordinate to similar rights of other classes of securities which are senior or become senior to the company's common stock. The financial instrument's participation percent upon occurrence of a liquidity event is negotiated at the time the financial instrument is issued and may be adjusted for subsequent securities issuances on a common share equivalent basis.

### BRIEF DESCRIPTION OF THE DRAWINGS

The present invention satisfies the general needs noted above and provides many advantages, as will become apparent from the following description when read in conjunction with the accompanying drawings, wherein:

FIG. 1 is a system block diagram depicting the use of the present invention in a business relationship;

FIG. 2 is a block diagram depicting attributes of the financial instrument;

FIG. 3 is a system block diagram depicting the use of the present invention in a business relationship where the holder is bound by preexisting conflict of interest rules;

FIG. 4 is a flow chart for the issuance phase of the exemplary transaction; and

FIG. 5 is a flow chart for the payment phase of the exemplary transaction.

### DETAILED DESCRIPTION OF A PREFERRED EMBODIMENT

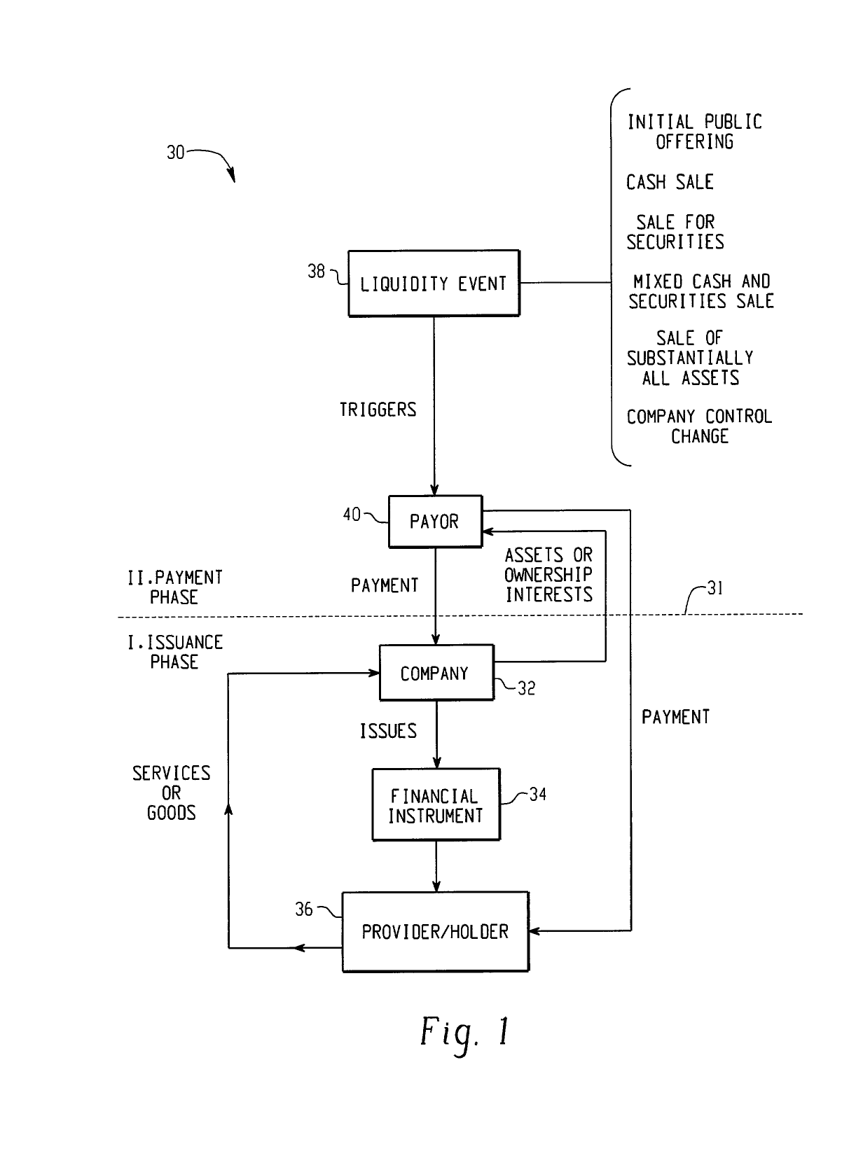

FIG. 1 depicts generally the system 30 for using the present invention in a business relationship. An exemplary scenario in which the present invention could be used involves a law firm or other professional advisor 36 providing services to a company 32. Such professional advisors typically are bound by preexisting conflict of interest rules that constrain how the advisors can collect fees for goods and services provided to the company 32. The present invention allows the professional advisors 36 to take equity interests in the company 32 without running afoul of preexisting conflict of interest rules. Such equity interests provide the professional advisor 36 with opportunities to receive cash payments upon the occurrence of a predefined liquidity event 38, thus allowing the professional advisor 36 to earn substantially higher fees for services rendered than would otherwise be possible.

The exemplary transaction of FIG. 1 occurs in two phases: the issuance phase (Phase I) and the payment phase (Phase II). Division line 31 depicts the separation of phases in the transaction. In the issuance phase, the company 32 issues a financial instrument 34 to a provider of services 36. After the issuance of the financial instrument 34 to the provider 36, the provider 36 is termed a “holder” of the financial instrument 34. The financial instrument 34 is constructed in such a manner so as to achieve equity participation for the holder 36, allowing the holder 36 to participate in the equity growth and value appreciation of company 32. The financial instrument 34 insulates the holder 36 from conflicts of interest and the perception of conflicts of interest arising from the differing interests of stakeholders in the company 32. The company 32 avoids a charge to its earnings for financial reporting purposes on the payment received by the holder 36. The company 32 is able to pay for services from the holder 36 without using cash because the company 32 uses the financial instrument 34 at least partially as the payment medium from the company 32 and the holder 36.

The issuance of the financial instrument 34 to the holder 36 may be pursuant to the terms of a negotiated business arrangement between the company 32 and the holder 36. Such a negotiated business arrangement usually involves the provision of goods and/or services by the holder 36 to the company 32.

During Phase II (the payment phase) as demarcated by division line 31, a liquidity event 38 triggers the obligation of a payor 40 to make payments to the company 32 and the holder 36. The liquidity event 38 may be an initial public offering (IPO) of stock in the company 32, a sale of the company 32 for cash, a sale of the company 32 for securities, a sale of the company 32 for a combination of cash and securities, a sale of substantially all the assets of the company 32, a change in the control of the company 32, another such event as may be defined by the terms of the financial instrument 34, or such event that may be understood as a liquidity event by those skilled in the art.

The payor 40 may not be identified until the liquidity event 38 triggers the obligation of the payor 40 to make payments to the company 32 and the holder 36. In the instances where the company 32 is able to predict the occurrence of the liquidity event 38, the company 32 may select the payor 40, in which case payor 40 is identified prior to the occurrence of the liquidity event 38. Such a scenario occurs when the company 32 has an IPO of stock and selects a managing underwriter in connection with such an IPO. The managing underwriter may then be payor 40. However, in some instances, the identity of the payor 40 is unknown until after the liquidity event 38 has occurred. Such a scenario occurs when the company 32 is forced into bankruptcy by its creditors. In bankruptcy, the trustee in bankruptcy or debtor in possession may be the payor 40. Alternate embodiments of the present invention include the selection of the payor 40 by the company 32 being made at any time, including selections made prior to, contemporaneous with, or following the issuance of the financial instrument 34.

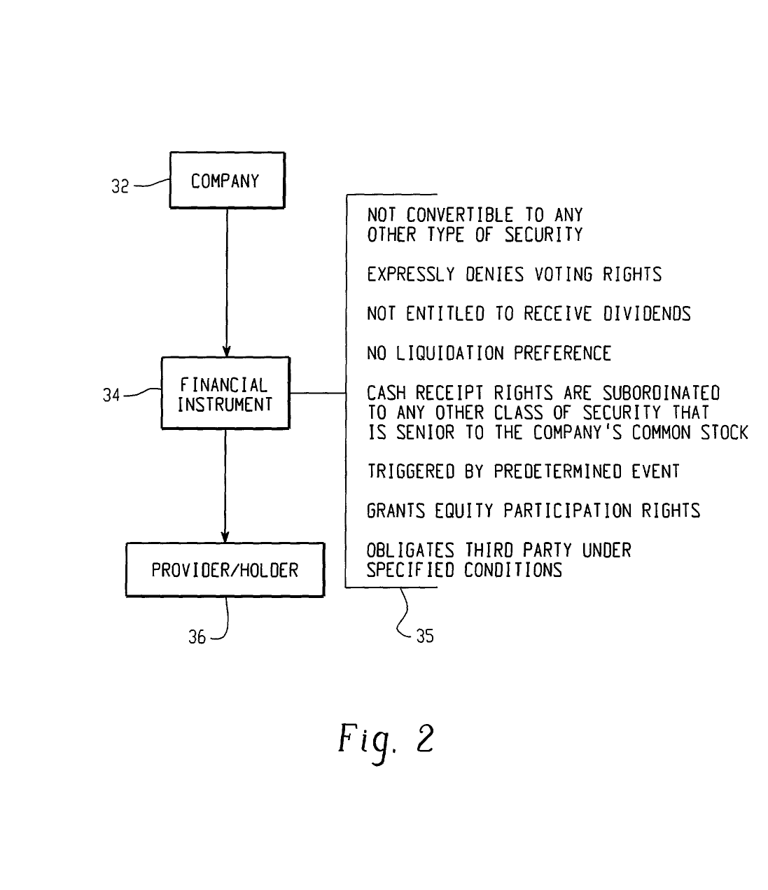

FIG. 2 depicts a list of attributes that the financial instrument 34 may contain. The attributes are structured in such a way as to allow the holder 36 to enjoy the benefits of a liquidity event while avoiding both the appearance of conflicts of interest and actual conflicts of interest along with other concerns which may arise from the existence of preexisting conflict of interest rules.

As shown by attribute list 35, the financial instrument 34 may contain one or more attributes as required by a specific situation. For example, the financial instrument 34 may have the attribute that it cannot be converted into any other type of security, thereby preventing such a conversion from defeating the unique aspects of the financial instrument 34. The financial instrument 34 may also expressly deny voting rights to the holder 36 so that the holder 36 is prevented from participating in the management or control of the company 32. The inability of the holder 36 to participate in the management or control of the company 32 removes potential and/or actual conflicts which may arise when certain proposed actions by the company 32 will not be in the interests of the holder 36. The holder 36 may also not be entitled to receive any payments of dividends from the financial instrument 34. The lack of dividend payments to the holder 36 is designed to remove potential or actual conflicts that may arise from differing stakeholder rights or interests in the resources of company 32 available to pay such dividends.

Because the financial instrument 34 is designed to participate in “upside liquidity” events like IPOs, the financial instrument 34 does not have a liquidation preference. Because the financial instrument 34 does not have a liquidation preference, the financial instrument 34 is valueless in a traditional liquidation for the benefit of creditors. In a preferred embodiment of the present invention, the financial instrument 34 has no right to receive any payment directly from the company. However, alternate embodiments that do contain such right to payment or payments from the company 32 will be apparent to those with ordinary skill in the art.

Cash receipt rights contained within the financial instrument 34 are subordinated to the cash receipt rights of any other class of security that is senior, or becomes senior to the common stock of the company 32. This subordination feature is designed so that classes of preferred stock of the company 32 issued to venture investors can maintain mandatory redemption rights and minimum value rights that typically are triggered by a change of control of the company 32. The subordination feature also removes the need for the holder 36 to consent to new issuances of securities by the company 32 which may occur in future rounds of financing. With such subordination feature, the holder 36 can remain silent and passive on such issuance or financing matters and avoid any potential or actual conflicts which may arise from the need to obtain the consent of the holder 36.

The cash receipt rights of financial instrument 32 are triggered by the predetermined liquidity event. Such cash receipt rights operate in conjunction with the equity participation rights of the financial instrument 34. These participation rights are equity linked so that the amount of cash received by the holder 36 upon the occurrence of the liquidity event 38 is based upon the market value of the company 32. For example, if thirty percent of the company 32 is sold in an IPO for $60 million in gross proceeds, the total IPO market capitalization of the company 32 is $200 million and a one percent participation right is worth $2 million. The participation percent may be negotiated at the time that the company and the holder enter into the business arrangement and adjusted for subsequent securities issuances on a common share equivalent basis so that the participation percentage is appropriately adjusted to the same extent as the holder of outstanding common stock on the date of issuance of the financial instrument. The participation percent may also be adjusted in the case of a private sale of the company to reflect the interest of the combined company received by the selling shareholders.

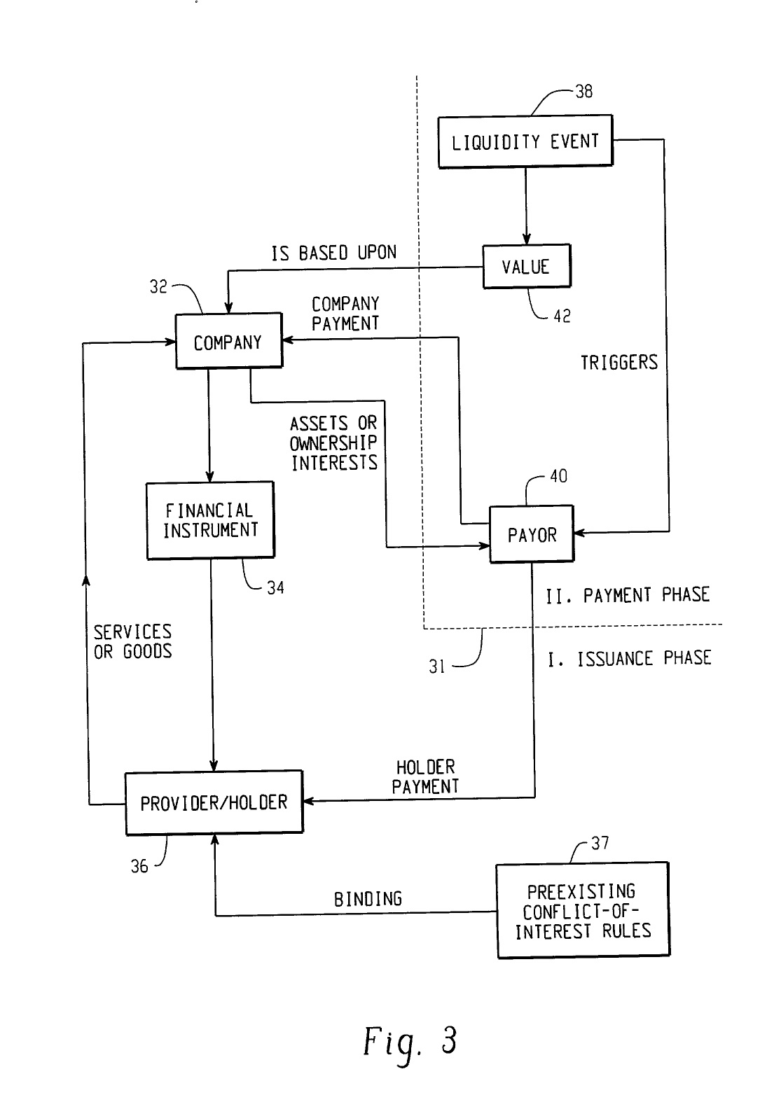

FIG. 3 depicts the operation of the system 30 that involves a holder 36 bound by preexisting conflict of interest rules 37. The preexisting conflict of interest rules 37 control in part how the holder 36 may provide services to the company 32.

The occurrence of the liquidity event 38 allows the holder 36 to receive compensation based upon the value 42 of the company 32. The company 32 transfers its assets or ownership interests to the payor 40 as part of the exemplary transaction. The liquidity event 38 triggers the obligation of the payor 40 to make payments to the company 32 and the holder 36. The payment from the payor 40 to the company 32 may be to the company itself or to the individuals with the ownership interests in the company 32. For example, when the liquidity event 38 is a sale of the company 32, and the company 32 is a corporation, the shareholders of the company 32 would receive payment individually based upon each shareholder's proportionate ownership interest.

The payment from the payor 40 to the holder 36 is direct. In an embodiment of the present invention, the source of the payment from the payor 40 to the holder 36 is the capital markets as part of an IPO. Because the payment from the payor 40 to the holder 36 is direct and has its source in the capital markets, such payment is not a liability of the company 32 and also is not a charge to the earnings of the company 32 for financial reporting purposes. Additionally, such payment from the payor 40 to the holder 36 is not perceived as a cash fee payment by the company 32 which has the advantage of not being a drain on the available cash and general financial resources of company 32.

Where the liquidity event is a sale of the company for consideration consisting of unregistered securities by a private issuer, the cash receipt rights of the financial instrument are not triggered. In this scenario, the financial instrument becomes a security of the private purchaser and the participation percent is adjusted to reflect the percentage of the combined entity received by the company shareholders.

Where the liquidity event is a sale of the company for consideration consisting of registered securities, the liquidity transaction is treated in the same manner as a cash sale. The holder of the financial instrument receives the right to acquire the registered securities of the purchaser to the extent of the holder's participation right in much the same way as the holder would receive cash in a cash sale transaction. The holder may then sell the registered securities on the open market as it deems appropriate.

For purposes of the financial instrument, a transaction may be classified as a registered security transaction where the purchaser is obligated to register its securities within a reasonable amount of time to address transactions where there is a registration obligation, or where the transaction is in conjunction with an IPO by the purchaser.

The holders of the financial instrument automatically agree by the terms of the financial instrument to any limitation on sale provisions that are agreed to by a specified percentage of the common shareholders. Such a limitation is designed so that the holder does not appear to be in a more advantageous position with regard to such limitation than the common shareholders and does not require the affirmative consent or any contractual undertaking by the holder in conjunction with the liquidity transaction.

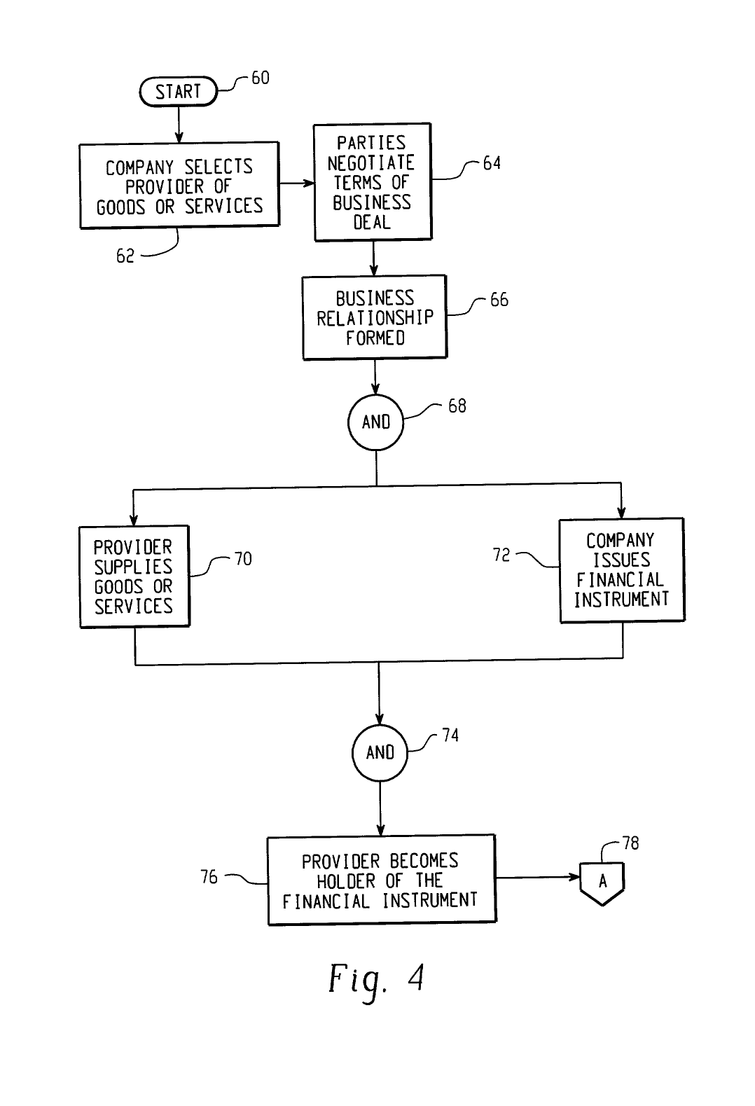

FIG. 4. shows a flow chart that depicts the steps used by the present invention. START block 60 indicates that process block 62 is performed wherein the company selects a provider of goods or services. At process block 64, the parties negotiate the terms of the business deal. Upon completion of negotiations, a business relationship is formed between the company and provider as shown by process block 66.

Process blocks 70 and 72 are the next process blocks to be performed. In process block 70 the provider supplies goods or services to the company. In process block 72 the company issues the financial instrument to the provider. In process block 76, the provider 36 becomes the holder of the financial instrument 34.

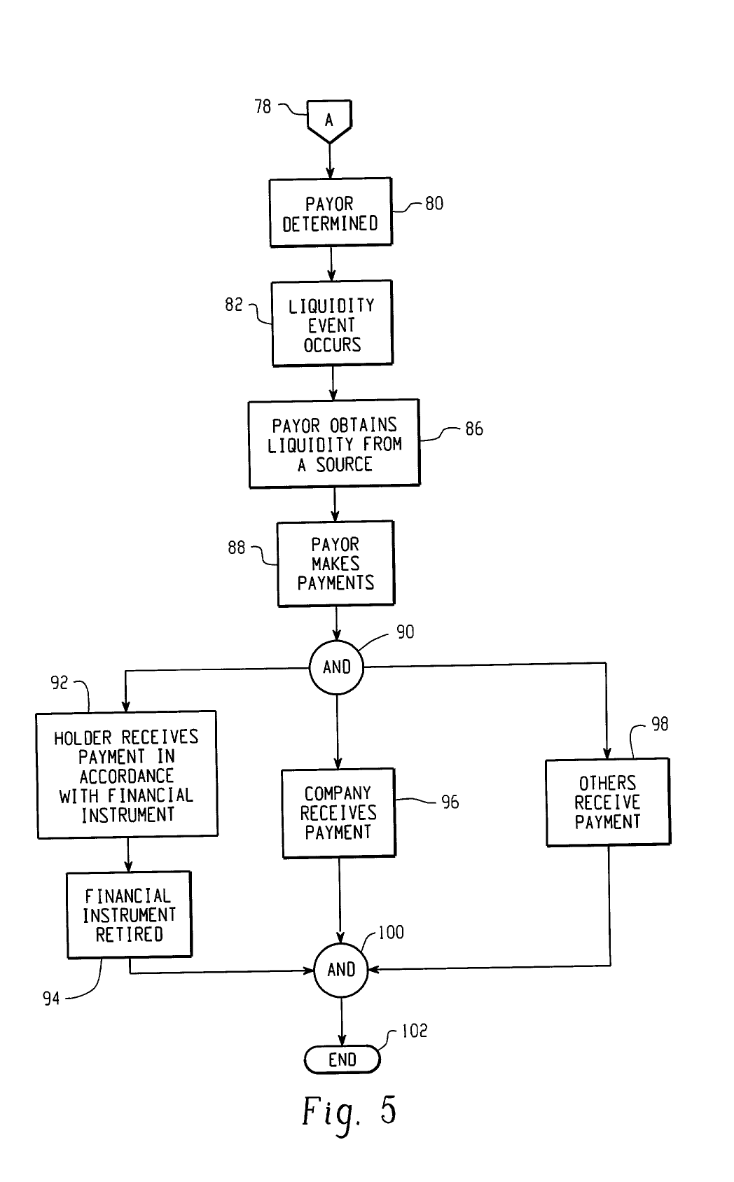

AND blocks 60 and 74 demarcate which process blocks may be performed at different times relative to each other. Process blocks 70 and 72 are located on different branches within AND block 60 and 74 and thus depending upon the actual situation at hand may be performed at different times relative to each other. Such different times include: process block 70 occurring before process block 72; process block 70 occurring during process block 72; or process block 70 occurring after process block 72. The process continues in FIG. 5 as indicated by continuation block 78.

With reference to FIG. 5, the payor is selected at process block 80. Process block 82 indicates the occurrence of the liquidity event. At process block 86 the payor obtains liquidity from a source, in this example, the capital markets. The payor makes payments at process block 88. AND blocks 90 and 100 indicate the following activities may occur at different times relative to activities on other branches. The order of the activities may be dictated by the financial instrument. In process block 92 the holder receives a cash payment in accordance with the financial instrument. After such payment, the financial instrument is retired in process block 94. In process block 96 the company receives payment from the payor. In process block 98, other parties who may become involved in the exemplary transaction receive payment. It is not necessary for all of the activities depicted between AND block 90 and AND block 100 to occur. For example, in some scenarios, process block 98 may not be executed. Activity related to this exemplary scenario terminates at END block 102.

The preferred embodiment described with reference to the drawing figures is presented only to demonstrate an example of the invention. Additional and/or alternative embodiments of the invention will be apparent to one of ordinary skill in the art upon reading this disclosure. For example, any type of company may utilize the present invention's financial instrument in its business dealings. Accordingly, the term company used herein is broad and includes, but is not limited to, corporations, partnerships, limited partnerships, limited liability companies, professional corporations, professional associations, limited liability partnerships, business trusts, and any other similar business entity, as well as those who have ownership interests in such entities (e.g., shareholders, partners, beneficiaries, etc.).

It is claimed:

1. A financial instrument issued by a company to a holder in order to compensate for services rendered to the company by the holder, said financial instrument comprising an obligation that a payor other than the company pay the holder when a predetermined event occurs.

2. The financial instrument of claim 1 wherein payment by the payor is based upon the company's value.

3. The financial instrument of claim 2 wherein the company's value is determined at substantially the time of the predetermined event.

4. The financial instrument of claim 1 wherein the services include providing goods to the company.

5. The financial instrument of claim 1 wherein the payor is identified at the time the company issues the financial instrument to the holder.

6. The financial instrument of claim 1 wherein the payor is identified not until about the time of the predetermined event.

7. The financial instrument of claim 1 wherein the payor is identified after the company issues the financial instrument to the holder.

8. The financial instrument of claim 1 wherein the predetermined event is a liquidity event involving the company.

9. The financial instrument of claim 1 wherein the predetermined event includes sale of the company.

10. The financial instrument of claim 1 wherein the predetermined event includes a merger involving the company.

11. The financial instrument of claim 1 wherein the predetermined event includes an initial public offering (IPO) involving the company.

12. The financial instrument of claim 1 wherein the obligation is in compliance with pre-existing conflict rules which the holder has a duty to observe when providing the holder's services to the company.

13. The financial instrument of claim 12 wherein the pre-existing conflict rules are the conflict rules from at least one state of the United States.

14. The financial instrument of claim 13 wherein the pre-existing conflict rules include attorney conflict rules that govern compensations for services rendered by attorneys to clients.

15. The financial instrument of claim 14 wherein the holder includes at least one attorney who has a duty to observe the attorney conflict rules.

16. The financial instrument of claim 12 wherein the holder includes at least one accountant who has a duty to observe accountant conflict rules.

17. The financial instrument of claim 12 wherein the pre-existing conflict rules include non-attorney conflict rules that govern compensations for services rendered by non-attorneys to clients.

18. The financial instrument of claim 1 wherein the compensation by the financial instrument to the holder is a partial compensation for services rendered to the company by the holder.

19. The financial instrument of claim 1 wherein the compensation by the financial instrument to the holder is compensation for all services rendered to the company by the holder.

20. A method that compensates for services rendered on behalf of a company, comprising the steps of:
negotiating contractual terms between a holder and the company regarding compensation for services rendered by the holder to the company;
generating a financial instrument based upon the negotiated contractual terms such that the financial instrument is to be issued by the company to the holder as compensation for the services rendered to the company by the holder, said financial instrument including an obligation that a payor other than the company pay the holder when a predetermined liquidity event occurs, said obligation being in compliance with pre-existing conflict rules which the holder has a duty to observe when providing the holder's services to the company; and
issuing the financial instrument to the holder as the payment, wherein the payor is unidentified at time of the issuing.

21. The method of claim 20 wherein payment by the payor is based upon the company's value.

22. The method of claim 21 wherein the company's value is determined at substantially the time of the predetermined event.

23. The method of claim 20 wherein the services includes providing goods to the company.

24. The method of claim 20 wherein the predetermined event is a liquidity event involving sale of assets of the company.

25. The method of claim 20 wherein the predetermined event includes sale of the company.

26. The method of claim 20 wherein the predetermined event includes a merger involving the company.

27. The method of claim 20 wherein the predetermined event includes an initial public offering (IPO) involving the company.

28. The method of claim 20 wherein the obligation is in compliance with pre-existing conflict rules of a geographic region which the holder has a duty to observe when providing the holder's services to the company.

29. The method of claim 28 wherein the pre-existing conflict rules are the conflict rules from at least one state of the United States.

30. The method of claim 29 wherein the pre-existing conflict rules include attorney conflict rules that govern compensations for services rendered by attorneys to clients.

31. The method of claim 30 wherein the holder includes at least one attorney who has a duty to observe the attorney conflict rules.

32. The method of claim 28 wherein the holder includes at least one accountant who has a duty to observe accountant conflict rules.

33. The method of claim 28 wherein the pre-existing conflict rules include non-attorney conflict rules that govern compensations for services rendered by non-attorneys to clients.

34. The method of claim 20 wherein the compensation by the financial instrument to the holder is a partial compensation for services rendered to the company by the holder.

35. The method of claim 20 wherein the compensation by the financial instrument to the holder is compensation for all services rendered to the company by the holder.

36. A method that compensates for services rendered on behalf of a company, comprising the step of:
(a) providing payment to a holder according to terms of a financial instrument issued from the company to the holder;
said financial instrument specifying terms for compensation for the services rendered to the company by the holder, said financial instrument including an obligation that a payor other than the company pay the holder when a predetermined event occurs, wherein the payor is unidentified at time of creation of the financial instrument;
said payor performing step (a) at about when the predetermined event occurs.

37. The method of claim 36 further comprising the step of:
acquiring the company that issued the financial instrument.

38. The method of claim 36 wherein creation of the financial instrument is when the financial instrument is issued to the holder.
